(19) United States
(12) Patent Application Publication
(10) Pub. No.: US 2005/0002563 A1
(43) Pub. Date: Jan. 6, 2005

(54) Gray-scale transformation processing device, electronic camera, and gray-scale transformation program

(75) Inventor: Hideo Hoshuyama, Takatsu-ku (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/874,251

(22) Filed: Jun. 24, 2004

(30) Foreign Application Priority Data
Jul. 1, 2003 (JP) 2003-270102

(51) Int. Cl. G06K 9/00; G06K 9/36

(52) U.S. Cl. 382/162

(57) ABSTRACT

The present invention provides a gray-scale transformation processing device which reduces the memory capacity for an LUT, and carries out gray-scale transformation with high accuracy. The gray-scale transformation processing device includes a data dividing unit, a lookup table, a transform function generating unit, and a gray-scale transforming unit. The data dividing unit divides digitally inputted image data into high-order bits data and low-order bits data. In the lookup table, the correspondences between the high-order bits data and correction coefficient groups providing transformation curves, respectively, are stored. The transform function generating unit generates a high-order gray-scale transform function from the correction coefficient group obtained from the lookup table. The gray-scale transforming unit calculates the low-order bits data with the gray-scale transform function to output image data, which has been subjected to gray-scale transformation.

### CROSS-REFERENCE TO RELATED APPLICATIONS

This application is based upon and claims the benefit of priority from the prior Japanese Patent Application No. 2003-270102, filed on Jul. 1, 2003, the entire contents of which are incorporated herein by reference.

### BACKGROUND OF THE INVENTION

1. Field of the Invention

The present invention relates to a gray-scale transformation processing device which is applied to an electronic camera, a scanner, a printer and the like.

2. Description of the Related Art

In image processing in an electronic camera and the like, photographed image data is subjected to gray-scale transformation such as gamma correction and the like, for the purpose of, for example, correcting a gray-scale characteristic specific to an imaging sensor, suiting the gray-scale characteristic to a nonlinear gray-scale display characteristic of a monitor and the like.

As a method for the gray-scale transformation, there are a method for providing a gray-scale transformation characteristic in an analog fashion, and a method for providing a gray-scale transformation characteristic in a digital fashion by use of a lookup table (LUT). In particular, the foregoing gray-scale transformation by use of the LUT is widely used because high-speed calculation is possible, and the gray-scale transformation has extremely high degree of flexibility in correction.

In the gray-scale transformation by use of the LUT, however, all numerical values of the gray-scale transformation characteristic have to be listed in a table and stored in memory in advance. Volume of data of the LUT increases with increasing the number of bits of image processing data. Taking the case of an LUT with 16-bit input and 16-bit output, memory capacity of approximately 131 kB is necessary. In particular, portable equipment such as an electronic camera and the like uses an ASIC (application specific integrated circuit) for the purpose of miniaturization and power conservation. Considering cost, it is preferable to reduce the memory capacity for the LUT in the ASIC as much as possible.

Japanese Unexamined Patent Application Publication No. 6-233131 discloses the technology for reducing memory capacity for an LUT by approximating a transformation curve by use of polygonal line approximation. In the Japanese Unexamined Patent Application Publication No. 6-233131, after image data is divided into bits, high-order bits data is inputted to the LUT to obtain the slope of a transform function and a reference output value. Then, linear interpolation calculation is carried out with the use of low-order bits data, to obtain image data which has been subjected to gray-scale correction.

In the technology disclosed in the Japanese Unexamined Patent Application Publication No. 6-233131, however, since the transformation curve of gray-scale correction is approximated by polygonal lines, it is extremely difficult to express subtle gradations of the nonlinear transformation curve. In the case that the segment number of the polygonal lines increases, accuracy in the polygonal line approximation increases. The memory capacity for the LUT, however, also increases, so that there is room for improvement at this point.

### SUMMARY OF THE INVENTION

The present invention aims to solve the foregoing problem in the related art, and an object of the present invention is to provide a gray-scale transformation processing device that can carry out gray-scale transformation with high accuracy while reducing the memory capacity for an LUT.

A gray-scale transformation processing device according to the present invention includes a data dividing unit, a lookup table, a transform function generating unit, and a gray-scale transforming unit. The data dividing unit divides digitally inputted image data into high-order bits data and low-order bits data. In the lookup table, correspondences between the high-order bits data and correction coefficient groups providing transformation curves, respectively, are stored. The transform function generating unit generates a gray-scale transform function of a curved function from the respective correction coefficient groups obtained from the lookup table. The gray-scale transforming unit calculates the low-order bits data with the gray-scale transform function to output image data, which has been subjected to gray-scale transformation.

In the gray-scale transformation processing device according to the present invention, the lookup table stores the correspondences between the high-order bits data and the correction coefficient groups, each of which includes a coefficient of a second term, a coefficient of a first term, and a coefficient of a constant term, so that the transform function generating unit can generate a quadratic gray-scale transform function.

In the gray-scale transformation processing device according to the present invention, the digitally inputted image data is divided into the high-order bits data and the low-order bits data by the data dividing unit. The high-order bits data is inputted into the lookup table, and the correction coefficient group corresponding to this high-order bits data is outputted to the transform function generating unit. The high-order gray-scale transform function is generated on the basis of the correction coefficient group in the transform function generating unit, and the gray-scale transform function is outputted to the gray-scale transforming unit. The low-order bits data, on the other hand, is inputted into the gray-scale transforming unit. In the gray-scale transforming unit, the low-order bits data is substituted into the gray-scale transform function, to generate image data which has been subjected to gray-scale transformation.

According to the present invention, since image data is generated by the gray-scale transform function based on the correction coefficient group, only data of the correction coefficient groups is stored in the lookup table. Therefore, it is possible to substantially reduce the volume of the lookup table. Furthermore, since the gray-scale transform function according to the present invention is a high-order function, accuracy in approximation to a transformation curve is high. Therefore, it is possible to carry out gray-scale transformation with high accuracy, by which subtle gradations of the transformation curve are expressed with high fidelity.

An electronic camera according to the present invention includes an imaging part which takes an image of a subject and generates image data, and the foregoing gray-scale transformation processing device according to the present invention.

A gray-scale transformation processing program according to the present invention has a lookup table, in which the correspondences between input data and correction coefficient groups providing transformation curves, respectively, are stored. The gray-scale transformation processing program makes a computer carry out a data dividing step, a correction coefficient group obtaining step, a transform function generating step, and a gray-scale transformation step. Digitally inputted image data is divided into high-order bits data and low-order bits data in the data dividing step. In the correction coefficient group obtaining step, the high-order bits data is transformed to the correction coefficient groups, respectively, by use of the lookup table. A gray-scale transform function of a curved function is generated by use of the respective correction coefficient groups in the transform function generating step. Then, the low-order bits data is calculated with the gray-scale transform function in the gray-scale transforming step.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a schematic diagram of an electronic camera in which a gray-scale transformation processing device according to the present invention is installed; and

FIG. 2 is a table showing an example of data set as an LUT.

### DESCRIPTION OF THE PREFERRED EMBODIMENT

An embodiment of the present invention will be hereinafter described in detail on the basis of drawings.

### The Structure of a Gray-Scale Transformation Processing Device According to this Embodiment

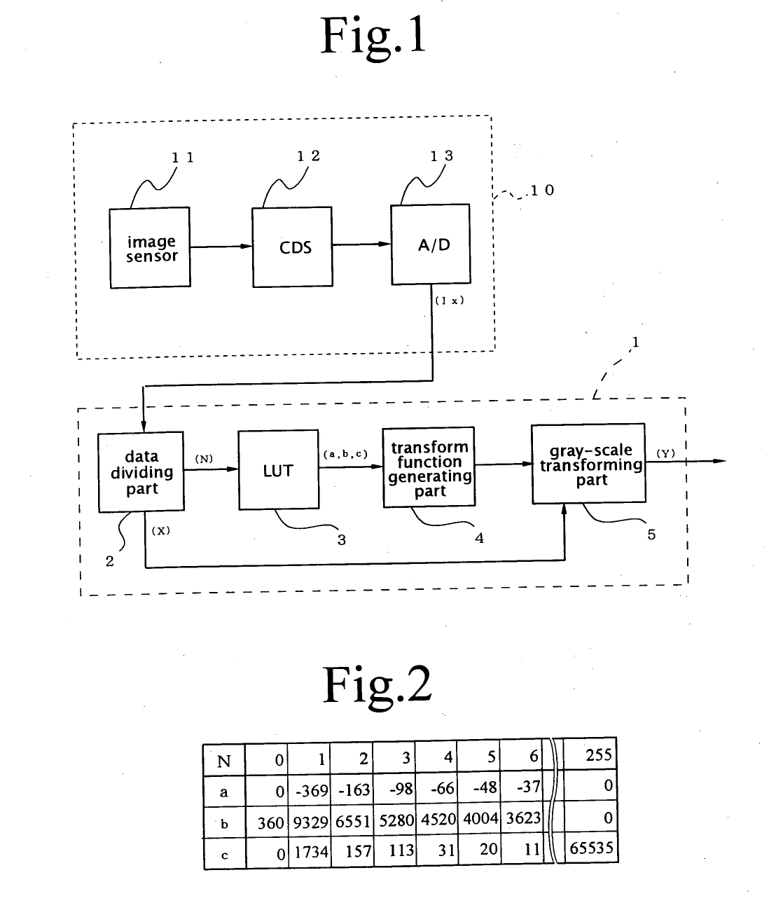

FIG. 1 is a schematic diagram of an electronic camera in which a gray-scale transformation processing device 1 according to the present invention is installed.

In this embodiment, an imaging part 10 includes an imaging sensor 11, a CDS circuit 12, and an A/D converter 13. An output of the imaging part 10 is connected to the gray-scale transformation processing device 1. The gray-scale transformation processing device 1 includes a data dividing part 2, a lookup table (LUT) 3, a transform function generating part 4, and a gray-scale transforming part 5.

The data dividing part 2 divides image data (Ix) digitally inputted from the imaging part 10 into high-order bits data (N) and low-order bits data (X) by a predetermined number of bits. Output of the data dividing part 2 is connected to the LUT 3 and the gray-scale transforming part 5. The high-order bits data (N) is outputted to the LUT 3, and the low-order bits data (X) is outputted to the gray-scale transforming part 5.

The LUT 3 includes a data storage part and a data readout part. In the data storage part of the LUT 3, the correspondences between the high-order bits data (N) and correction coefficient groups are stored. Each of the correction coefficient groups stored in the data storage part, for example, as shown in FIG. 2, is composed of three types of data, which are a coefficient of the second term “a”, a coefficient of the first term “b”, and a coefficient of a constant term “c”. The data readout part of the LUT 3 reads data (a, b, c) of the correction coefficient group corresponding to the inputted high-order bits data (N), from the data storage part, to output the correction coefficient group to the transform function generating part 4.

The transform function generating part 4 generates a quadratic gray-scale transform function from data (a, b, c) of the correction coefficient group inputted from the LUT 3. Data of the gray-scale transform function generated by the transform function generating part 4 is outputted to the gray-scale transforming part 5.

In the gray-scale transforming part 5, the low-order bits data (X) is calculated with the gray-scale transform function generated by the transform function generating part 4, to generate gray-scale transformed image data (Y). Output from the gray-scale transforming part 5 is connected to a monitor display part, a storage part for storing compressed image signals and the like through buses of the electronic camera (the buses, the monitor display part, and the storage part are not illustrated).

### The Operation of the Gray-Scale Transformation Processing Device According to this Embodiment

The operation of the gray-scale transformation processing device 1 according to this embodiment, which is structured as described above, will be hereinafter described.

When a user releases a shutter, the imaging sensor 11 carries out photoelectric conversion of a subject image. An image signal generated by the imaging sensor 11 is outputted from the imaging sensor 11 in synchronization with a clock supplied from a not-illustrated clock generating part. The CDS circuit 12 reduces a noise component of the image signal, which is read from the imaging sensor 11. Then, the image signal is converted into digital image data (Ix) of 16-bit by the A/D converter 13, and is outputted to the gray-scale transformation processing device 1.

The data dividing part 2 of the gray-scale transformation processing device 1 divides the inputted 16-bit image data (Ix) into high-order bits data (N) and low-order bits data (X). To be more specific, higher 8 bits of image data are assigned as high-order bits data, and lower 8 bits are assigned to low-order bits data.

The high-order bits data (N) generated by the data dividing part 2 is outputted to the LUT 3. The data readout part of the LUT 3 searches through information in the data storage part with reference to the inputted high-order bits data (N), to read data (data of a coefficient of the second term “a”, a coefficient of the first term “b”, and a coefficient of a constant term “c”) of a correction coefficient group corresponding to the high-order bits data (N), from the data storage part. The data readout part of the LUT 3 outputs read data (a, b, c) of the correction coefficient group to the transform function generating part 4.

The transform function generating part 4 substitutes data (a, b, c) of the correction coefficient group inputted from the LUT 3 into the following equation (1), respectively, to generate a quadric gray-scale transform function corresponding to the high-order bits data. Then, the generated gray-scale transform function is outputted to the gray-scale transforming part 5. The gray-scale transform function generates image data (Y), which has been subjected to gray-scale transformation processing, from the low-order bits data (X).
Y=(a/65536)X²+(b/1024)X+c equation (1)

The low-order bits data (X) generated by the data dividing part 2, on the other hand, is outputted to the gray-scale transforming part 5. In the gray-scale transforming part 5, a value of the inputted low-order bits data (X) is calculated with the gray-scale transform function generated by the transform function generating part 4, in order to generate 16-bit image data (Y) which has been subjected to the gray-scale transformation processing. Image data which has been subjected to the gray-scale transformation processing is compressed and encoded, and then is stored in a recording medium (a memory card or the like).

### The Effects of This Embodiment

In the gray-scale transformation processing device according to this embodiment, since the LUT is just composed of data of the correction coefficient groups, it is possible to substantially reduce the volume of the LUT. To be more specific, taking the case of 16-bit input and 16-bit output, a memory capacity of approximately 131 kB is necessary when all gray-scale transformation characteristics are listed in a table. In the case of this embodiment, however, the memory capacity of 1536B is enough. Especially, in the case of portable equipment such as an electronic camera and the like using an ASIC, difference in the memory capacity remarkably contribute to cost reduction.

Since the gray-scale transform function according to the this embodiment is a quadratic function, accuracy in approximation is high as compared with the case of linearly interpolating a transformation curve with polygonal lines. Therefore, it is possible to express subtle gradations of the transformation curve with high fidelity.

### Supplementary Terms of This Embodiment

The present invention has been described with reference to the preferred embodiment, but the technical scope of the present invention is not just limited to the foregoing embodiment. In the foregoing embodiment, for example, the quadratic function is used as the gray-scale transform function, but a function of a high order equal to or more than a cubic, an exponential function or the like may be used as the gray-scale transform function in accordance with the volume of the LUT. The setting of the number of bits of image data before and after the gray-scale transformation, and the number of bits of high-order bits data and low-order bits data are arbitrary changeable. Furthermore, an intended use of the gray-scale transformation processing device according to the present invention is not limited to the electronic camera. The gray-scale transformation processing device according to the present invention is applicable to other image processing equipment such as a scanner, a printer, and the like.

The invention is not limited to the above embodiments and various modifications may be made without departing from the spirit and scope of the invention. Any improvement may be made in part or all of the components.

1. A gray-scale transformation processing device comprising:
a data dividing unit dividing digitally inputted image data into high-order bits data and low-order bits data;
a lookup table, in which correspondences between said high-order bits data and correction coefficient groups providing transformation curves, respectively, are stored;
a transform function generating unit generating a gray-scale transform function of a curved function from the respective correction coefficient groups obtained from said lookup table; and
a gray-scale transforming unit calculating said low-order bits data with said gray-scale transform function to output image data having been subjected to gray-scale transformation.

2. The gray-scale transformation processing device according to claim 1, wherein
said lookup table stores the correspondences between said high-order bits data and the correction coefficient groups, each of which includes a coefficient of a second term, a coefficient of a first term, and a coefficient of a constant term, so that said transform function generating unit generates a quadratic gray-scale transform function.

3. An electronic camera comprising:
an imaging part taking an image of a subject and generating image data; and
a gray-scale transformation processing device including
a data dividing unit dividing digitally inputted image data into high-order bits data and low-order bits data,
a lookup table, in which correspondences between said high-order bits data and correction coefficient groups providing transformation curves, respectively, are stored,
a transform function generating unit generating a gray-scale transform function of a curved function from the respective correction coefficient groups obtained from said lookup table, and
a gray-scale transforming unit calculating said low-order bits data with said gray-scale transform function to output image data having been subjected to gray-scale transformation.

4. An electronic camera comprising:
an imaging part taking an image of a subject and generating image data; and
a gray-scale transformation processing device including
a data dividing unit dividing digitally inputted image data into high-order bits data and low-order bits data,
a lookup table, in which correspondences between said high-order bits data and correction coefficient groups providing transformation curves, respectively, are stored,
a transform function generating unit generating a gray-scale transform function of a curved function from the respective correction coefficient groups obtained from said lookup table, and
a gray-scale transforming unit calculating said low-order bits data with said gray-scale transform function to output image data having been subjected to gray-scale transformation, wherein
said lookup table stores the correspondences between said high-order bits data and the correction coefficient groups, each of which includes a coefficient of a second term, a coefficient of a first term, and a coefficient of a constant term, so that said transform function generating unit generates a quadratic gray-scale transform function.

5. A gray-scale transformation processing program having a lookup table, in which correspondences between input data and correction coefficient groups providing transformation curves, respectively, are stored, the gray-scale transformation processing program making a computer carry out:
a data dividing step dividing digitally inputted image data into high-order bits data and low-order bits data;
a correction coefficient group obtaining step transforming said high-order bits data to said correction coefficient groups, respectively, by use of said lookup table;
a transform function generating step generating a gray-scale transform function of a curved function by use of the respective correction coefficient groups; and
a gray-scale transformation step calculating said low-order bits data with said gray-scale transform function.
